(19) United States
(12) Patent Application Publication
(10) Pub. No.: US 2013/0254527 A1
(43) Pub. Date: Sep. 26, 2013

(54) BIOS FIRMWARE UPDATING METHOD AND ELECTRONIC DEVICE

(71) Applicant: YU-GANG ZHANG, Shenzhen City (CN)

(72) Inventor: YU-GANG ZHANG, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 13/452,957

(22) Filed: Apr. 23, 2012

(30) Foreign Application Priority Data
Mar. 20, 2012 (CN) 201210074803.2

(51) Int. Cl. G06F 9/44

(52) U.S. Cl. 713/100

(57) ABSTRACT

An electronic device includes a baseboard management controller (BMC) and a basic input output system (BIOS). The BMC includes a dynamic random access memory (DRAM) to store a firmware update of the BIOS. The BMC sets an identifier for the firmware update to a valid state if the DRAM receives the firmware update, and sets the identifier to an invalid state if the DRAM does not receive the firmware update. The BIOS is connected to the BMC, and determines whether the identifier is a valid state when the electronic device is started and updates the firmware of the BIOS with the firmware update if the identifier is a valid state.

### BACKGROUND

1. Technical Field

The present disclosure relates to electronic devices and, more particularly, to a basic input output system firmware updating method and an electronic device using the updating method.

2. Description of Related Art

A firmware of a basic input output system (BIOS) of an electronic device, such as a server, needs to be updated regularly. The server further includes a baseboard management controller (BMC). When the firmware of the BIOS needs to be updated, the BMC is first connected to the flash memory through a multiplex switch to store a firmware update of the BIOS to the flash memory, and then the BIOS is connect to the flash memory through the multiplex switch to update the firmware of the BIOS with the stored firmware update. However, the updating method needs the multiplex switch, which makes the updating structure complex. Therefore, a new updating method is desired.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view of an electronic device capable of using a basic input output system firmware updating method in accordance with an exemplary embodiment.

FIG. 2 is a module diagram showing a basic input output system of the electronic device of FIG. 1 in accordance with an exemplary embodiment.

FIG. 3 is a flowchart of a basic input output system firmware updating method in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

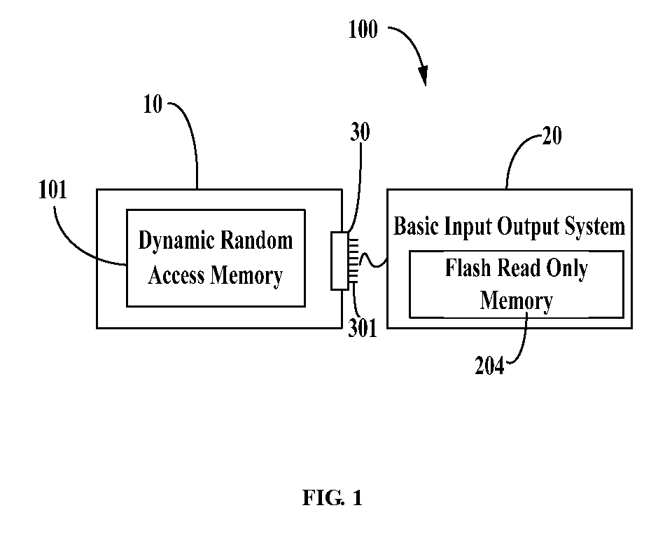

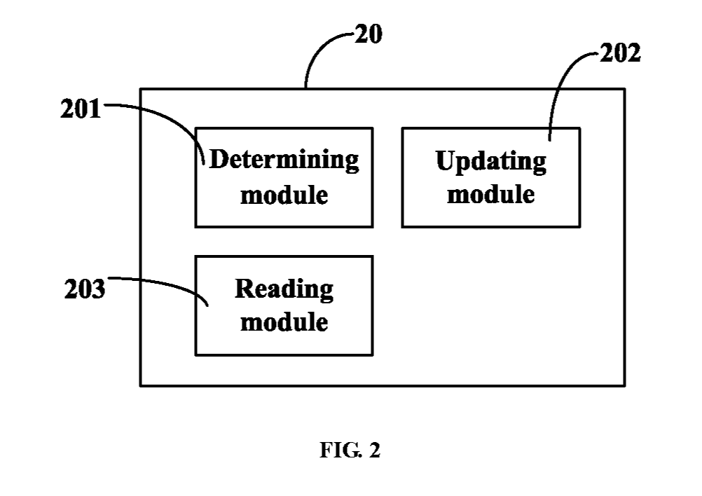

FIGS. 1 and 2 disclose an electronic device 100 including a baseboard management controller (BMC) 10 and a basic input output system (BIOS) 20. The BMC 10 is connected to the BIOS 20 through a Low Pin Count (LPC) interface 30. In this embodiment, the electronic device 100 is a server.

The BMC 10 includes a dynamic random access memory (DRAM) 101 for storing a firmware update of the BIOS 20. The DRAM 101 may receive the firmware update through a special storing interface provided by the BMC 10 in a network, allowing a user to store the firmware update through a remote device such as a computer connected to the network. The BMC 10 sets an identifier for the firmware update to indicate whether the DRAM 101 receives a firmware update of the BIOS 20 through a pin 301 of the LPC interface 30. The BMC 10 sets the identifier to a valid state if the DRAM 101 receives a firmware update, and the BMC 10 sets the identifier to an invalid state if the DRAM 101 does not receive a firmware update. For example, logical high level and logical low level are respectively used to represent the valid state and the invalid state. In this embodiment, the BMC 10 controls the electronic device 100 to restart after setting the identifier to a valid state.

In another embodiment, when the DRAM 101 receives a file, the BMC 10 determines whether the received file is a BIOS firmware update, for example, through the first 32 bits of the file, and sets the firmware identifier to a valid state if determining the received file is a BIOS firmware update.

The BIOS 20 includes a determining module 201 and an updating module 202. The determining module 201 determines whether the identifier is a valid state when the electronic device 100 is started. The updating module 202 updates the firmware of the BIOS 20 with the firmware update stored in the DRAM 101 if the identifier is a valid state. After having updated the firmware of the BIOS 20, the updating module 202 further transmits a setting signal to the BMC 10 for setting the identifier to an invalid state.

In this embodiment, the BIOS 20 further includes a reading module 203. The reading module 203 reads the firmware update in the DRAM 101 if the identifier is a valid state, and stores the read firmware update into a Flash Read Only Memory (ROM) 204 of the BIOS 20. The updating module 202 updates firmware of the BIOS 20 with the firmware update stored in the Flash ROM 204. In another embodiment, the reading module 203 stores the read firmware into a memory (not shown) of the electronic device 100. The updating module 202 updates the firmware of the BIOS 20 according to the firmware update stored in the memory of the electronic device 100.

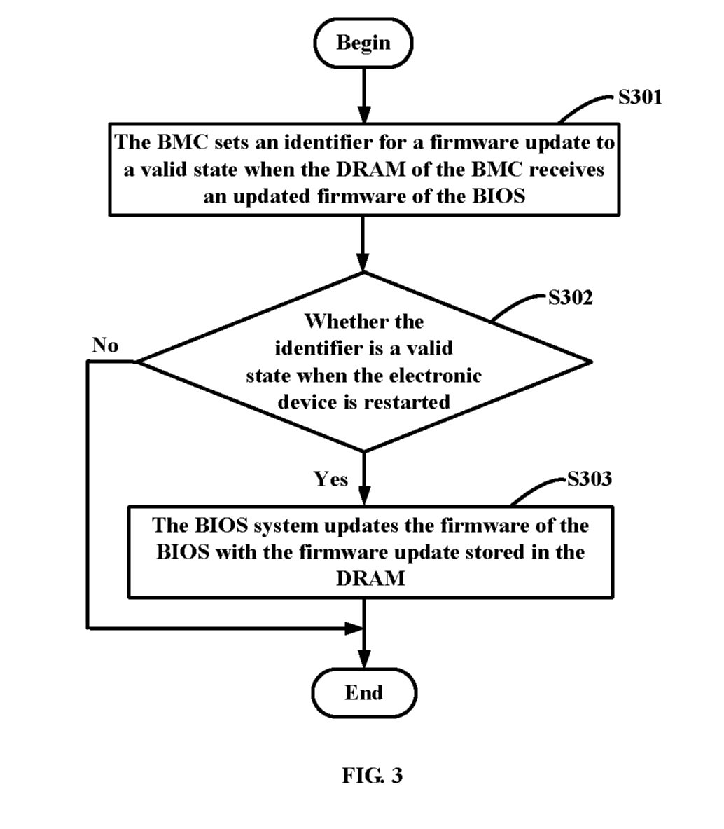

FIG. 3 is a flowchart of a basic input output system firmware updating method.

In step S301, the BMC 10 sets the identifier to a valid state if the DRAM 101 receives the firmware update of the BIOS 20.

In step S302, the determining module 201 is controlled by the BIOS 20 to determine whether the identifier is a valid state when the electronic device 100 is started.

If the identifier is a valid state, the procedure goes to S303, if determined otherwise, the procedure ends.

In step S303, the updating module 202 is controlled by the BIOS 20 to update the firmware of the BIOS 20 with the firmware update stored in the DRAM 101.

In this embodiment, in step S303, the reading module 203 is first controlled by the BIOS 20 to read the firmware update in the DRAM 101 when the identifier is a valid state, and store the read firmware update into the flash ROM 204 of the BIOS 20. The updating module 202 is controlled by the BIOS 20 to update the firmware of the BIOS 20 according to the firmware update stored in the flash ROM 204. After having updated the firmware of the BIOS 20, the updating module 202 is further controlled by the BIOS 20 to transmit a setting signal to the BMC 10 for setting the identifier to an invalid state.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a baseboard management controller, comprising:
a dynamic random access memory to receive and store a firmware update of a basic input output system, and the baseboard management controller setting an identifier for the firmware update to a valid state if the dynamic random access memory receives the firmware update, and setting the identifier to an invalid state if the dynamic random access memory does not receive the firmware update; and
the basic input output system connected to the baseboard management controller, comprising:
a determining module to determine whether the identifier is a valid state when the electronic device is started; and
an updating module to update the firmware of the basic input output system, with the firmware update stored in the dynamic random access memory if the identifier is a valid state.

2. The electronic device as described in claim 1, wherein the basic input output system further comprises a reading module to read the firmware update in the dynamic random access memory if the identifier is a valid state, and store the read firmware update into a flash read only memory of the basic input output system, and the updating module updates firmware of the basic input output system with the firmware update stored in the flash read only memory.

3. The electronic device as described in claim 1, wherein the basic input output system further comprises a reading module to read the firmware update in the dynamic random access memory if the identifier is a valid state, and store the read firmware update into a memory of the electronic device, and the updating module updates firmware of the basic input output system with the firmware update in the memory of the electronic device.

4. The electronic device as described in claim 2, wherein after having updated the firmware of the basic input output system, the updating module further transmits a setting signal to the baseboard management controller, for setting the identifier to an invalid state.

5. The electronic device as described in claim 2, wherein when the dynamic random access memory receives a file, the baseboard management controller determines whether the received file is a basic input output system firmware, and sets the identifier to a valid state if determining the received file is a basic input output system firmware.

6. The electronic device as described in claim 2, wherein the baseboard management controller controls the electronic device to restart after setting the identifier to a valid sate.

7. The electronic device as described in claim 1, wherein the baseboard management controller is connected to the basic input output system through a low pin count interface, and the identifier indicates whether the dynamic random access memory receives a firmware update of the basic input output system through a pin of the low pin count interface.

8. The electronic device as described in claim 1, wherein the dynamic random access memory receives the firmware update through a special storing interface provided by the baseboard management controller in a network.

9. A basic input output system firmware updating method for updating a basic input output system firmware of an electronic device, the electronic device comprising a baseboard management controller, the baseboard management controller comprising a dynamic random access memory for storing a firmware update of a basic input output system, the basic input output system firmware updating method comprising:
setting an identifier for the firmware update to a valid state if the dynamic random access memory receives a firmware update;
determining whether the identifier is a valid state when the electronic device is started; and
updating a firmware of the baseboard management controller with the firmware update stored in the dynamic random access memory if the identifier is a valid state.

10. The basic input output system firmware updating method as described in claim 9, wherein the updating step comprises:
reading the firmware update in the dynamic random access memory if the identifier is valid;
storing the read firmware update into a flash read only memory of the basic input output system; and
updating the firmware of the basic input output system with the read firmware update stored in the flash read only memory.

11. The basic input output system firmware updating method as described in claim 9, wherein the updating step comprises:
reading the firmware update in the dynamic random access memory if the identifier is a valid state;
storing the read firmware update into a memory of the electronic device; and
updating the firmware of the basic input output system with the read firmware update in the memory of the electronic device.
